(19) United States
(12) Patent Application Publication
(10) Pub. No.: US 2021/0095425 A1
(43) Pub. Date: Apr. 1, 2021

(54) METHOD OF PRINTING COLOURED PAPER

(71) Applicant: INNOVA ART LIMITED, Essex (GB)

(72) Inventor: Michael RAMOS-GONZALEZ, Essex (GB)

(73) Assignee: INNOVA ART LIMITED, Essex (GB)

(21) Appl. No.: 16/958,638

(22) PCT Filed: Nov. 16, 2018
(86) PCT No.: PCT/GB2018/000147

§ 371 Date: Jun. 26, 2020

(30) Foreign Application Priority Data
Dec. 1, 2017 (GB) 1720090.8

(51) Int. Cl. D21H 19/82; B41M 7/00; B41M 5/50; D21H 19/38

(52) U.S. Cl. CPC D21H 19/822; D21H 19/38; B41M 5/502; B41M 7/0018

(57) ABSTRACT

A method of manufacturing dyed paper, following a request for paper coloured in a specific Pantone®, the method comprising the steps of selecting coloured paper from an available supply which is dyed in a colour that is in the same colour category as the Pantone®, applying a white primer coating to at least one side of the selected paper, applying a layer of printable coating over the white primer coating; and printing a layer of the Pantone® colour requested on at least part of the printable coating.

The present invention relates to a method of printing coloured paper.

### BACKGROUND TO THE INVENTION

There a number of industries that require paper that has been dyed a precise colour. The luxury packaging industry is one such example of an industry that often has a desire to obtain paper products that have been coloured to a highly specific Pantone® colour to meet strict brand guidelines of the customer for which the packaging is being designed.

The industrial process involved in providing dyed paper requires significant investment for each individual colour and, as such, it is generally not commercially practical for paper companies to provide small scale batches of paper dyed to a specific Pantone® colour.

Consequently, luxury packaging companies are faced with having to either choose from a very limited number of shades of a particular colour that are available because their popularity has been such that the paper company has made the required investment for providing dyed paper in that shade, or order a sufficient amount of the paper produce to make it a worthwhile investment for the paper company to product that precise colour shade.

Every colour has a vast number of Pantone® versions and so the luxury packaging industry in particular has been severely limited in its development of branded packaging.

The present invention seeks to alleviate this problem by providing a method of manufacturing dyed paper of any chosen specific Pantone® colour, wherein the method is applicable for small or large batch manufacturing.

At present, the majority of paper mills that produce coloured paper have an assortment of up to 2500 colour shades available that they would produce annually in small quantities.

The present invention also seeks to provide a method a producing coloured paper that allows a paper mill to be able to offer 16.7 million shades of colour in small quantities.

The present method is suitable for rapid prototyping and proofing, providing a facsimile of the finished article as well as being applicable for small runs of finished products.

### STATEMENT OF INVENTION

According to a first aspect of the invention there is provided a method of manufacturing dyed paper, following a request for paper coloured in a specific Pantone®, the method comprising the steps of:
selecting coloured paper from an available supply which is dyed in a colour that is in the same colour category as the Pantone®;
applying a white primer coating to at least one side of the selected paper;
applying a layer of printable coating over the white primer coating; and
printing a layer of dye or pigment of the Pantone® colour requested on at least part of the printable coating.

Preferably the colour is printed using an inkjet printer.

According to a second aspect of the invention there is provided a paper product or sheet that comprises a first layer of dyed paper, a coating of a white primer and a further printable coating.

Preferably the coating is compatible with inkjet printers or inkjet printing devices.

Preferably the coating is compatible with dye or pigment inkjet printers.

Reference to the term “white” in the context of the primer includes any shade of white within the appropriately recognised spectrum.

The coating is an inkjet coating or resin that is compatible with both pigment and dye inkjet printers. The coating may alternatively, or additionally, be equally compatible with other print media such as, for example without limitation, latex, solvents, UV or laser toners.

The selected paper should be in the same colour category as the requested Pantone® so that the paper produced by the method has the same general colour running through its depth so that it appears as though the entire paper has been simply dyed the Pantone® colour in the traditional way. Any slight differences in shade within the same colour category would not be visible to the eye of the consumer.

The consistent colouring through the paper avoids any inconsistent and unsightly layers becoming apparent if the edges are exposed whilst the paper is cut to shape, for example.

### BRIEF DESCRIPTION OF THE DRAWINGS

One embodiment of the invention will now be described by way of example only, with reference to the accompanying FIGURE which is schematic illustration showing the layers of a piece of paper produced using the method.

### DETAILED DESCRIPTION OF PREFERRED EMBODIMENTS

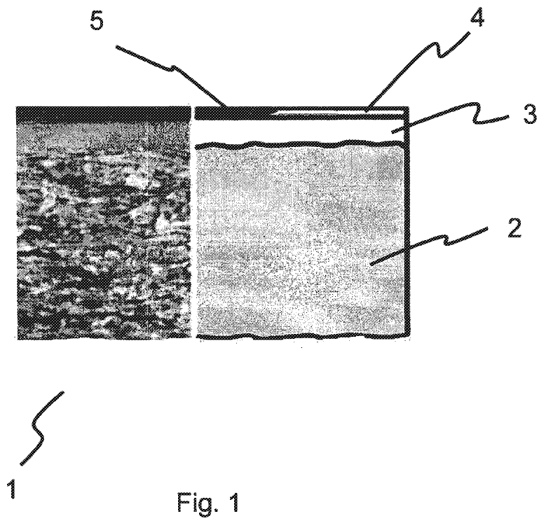

FIG. 1 which illustrates a cross section of a piece of coloured paper produced by the method described hereinafter.

The example provided is a piece of paper 1 that has only been coloured with the required Pantone® on one side. This would be primarily for the purpose of providing a prototype for the customer. It is of course evident that the layers on the printed side of the paper could be replicated on other side of the paper to provide a prototype that has the selected Pantone® colour printed on both sides. The method allows for different Pantone® colours to be printed on each side of the paper if, for example, the consumer would like a direct comparison of differing shades.

The paper 1 comprises a first paper layer 2 which is formed from a piece of available dyed paper that is selected because it is dyed with a colour that falls within the same colour category as the required Pantone®.

The first paper layer is coated with a second layer of white primer 3.

The second layer 3 is further coated with a printable coating or resin 4 which has been printed with a coloured dye or pigment 5 of the required Pantone® using an inkjet printer.

In the case where both sides of the paper are required in the required Pantone®, the paper layer 2 would form the middle layer of the paper 1, and the white primer 3 and then the printable coating or resin 4 would be applied to the both sides.

The method will now be described. Whilst reference is primarily made to the use of dye and pigments and inkjet printers therefore, it is appreciated that the method is equally applicable to any printing system or media capable of producing a colour accurate finish. The print media may, for example, include latex, solvents or UV as well as dyes and pigments.

The method would generally be followed pursuant to receiving a request or an order for a coloured paper of a specific Pantone® to be used for example in luxury packaging.

The method allows the desired coloured paper to be produced as a small batch, or even as an individual sheet, for testing purposes.

The first step of the method is to select dyed paper that is already available, or that can be produced from available means, which has a colour which matches the colour category of the Pantone® requested.

Once selected, the second step is to coat one or both sides of the paper in a white primer. This effectively provides a blank face on to which the colour Pantone® can be printed such that there is no underlying colour layer that could otherwise affect the shade, colour or appearance of the outer face of the final product.

Moreover, the presence of a white primer layer beneath the inkjet coating provides a base for any image of any colour combination.

A layer of printable coating or resin which is compatible with both pigment or dye inkjet printers is then applied over the white primer coating.

The inkjet coating is then printed with a pigment or dye of the chosen colour Pantone®.

The method allows for production of around 98% of available Pantone® colours in small batch orders which can then be provided to the customer for testing or approval.

This gives industries requiring coloured paper the ability to order small samples of paper of any Pantone® colour without having to incur significant financial investment for a bulk order. It also gives the ability of paper companies to offer samples of dyed paper of any available Pantone® colour.

The dyed paper produced as a result of the method hereinbefore described meets the same standards as traditional dyed paper and can be finished with conventional downstream finishing requirements such as, for example without limitation, embossing, hot foil stamping or scoring and folding.

1. A method of producing paper of a company-specified colour so as to create an overall appearance of being dyed in said company-specified colour, the method comprising the steps of:
selecting coloured paper from an available supply that is dyed in a colour in a same colour category as that of the company-specified colour;
applying a white primer coating to at least one side of the selected coloured paper;
applying a layer of printable coating over the white primer coating; and
printing the company-specified colour on at least part of the printable coating.

2. A method according to claim 1, wherein the company-specified colour is printed using an inkjet printer.

3. A method according to claim 1, wherein a layer of dye of or pigment of the company-specified colour is printed on the printable coating.

4. A paper product or sheet of a company-specified first colour comprising a first layer of dyed paper that is dyed in a selected second colour so as to create an overall appearance of being dyed in said company-specified first colour, a second layer or coating of a white primer applied to at least one side of the selected coloured paper, and a third layer of a printable coating applied to said second layer or coating.

5. A paper product made by the method of claim 1, wherein the coating is compatible with inkjet printers or with inkjet printing devices.

6. A paper product made by the method of claim 1, wherein the coating is compatible with dye or pigment inkjet printers.

7. The method according to claim 1 comprising:
applying the coating with an inkjet printer.

8. The method according to claim 1 comprising:
applying the coating with an inkjet printing device.

9. The method according to claim 1 comprising:
using a coating that is compatible with dye or pigment inkjet printers.
